(19) United States
(12) Patent Application Publication
(10) Pub. No.: US 2019/0136700 A1
(43) Pub. Date: May 9, 2019

(54) CERAMIC MATRIX COMPOSITE TIP SHROUD ASSEMBLY FOR GAS TURBINES

(71) Applicant: Siemens Aktiengesellschaft, München (DE)

(72) Inventors: Nicholas F. Martin, JR., York, SC (US); Christian Xavier Campbell, West Hartford, CT (US)

(73) Assignee: Siemens Aktiengesellschaft, München (DE)

(21) Appl. No.: 16/300,285

(22) PCT Filed: Jun. 22, 2016
(86) PCT No.: PCT/US16/38719

§ 371 Date: Nov. 9, 2018

(51) Int. Cl. F01D 5/22; F01D 5/14; F01D 11/08; F01D 5/18

(52) U.S. Cl. CPC F01D 5/225; F01D 5/147; F05D 2220/32; F01D 5/187; F05D 2300/6033; F01D 11/08

(57) ABSTRACT

A blade and tip shroud assembly for a gas turbine engine. The assembly includes at least one blade with an airfoil extending span-wise along a radial direction. Each blade includes a blade tip. At least one tenon extends radially out from the blade tip. A ceramic matrix composite (CMC) tip shroud is positioned along the blade tip. The CMC tip shroud extends along a circumferential direction and includes an upstream edge and a downstream edge spaced apart from each other in an axial direction. The CMC tip shroud includes a radially inner diameter (ID) surface adjoining the blade tip and a radially outer diameter (OD) surface opposite to the radially ID surface. A securing mechanism is connected to the OD surface of the CMC tip shroud and attached to the at least one tenon that extends through the CMC tip shroud.

### BACKGROUND

### 1. Field

The present invention relates to turbine engines, and more specifically to a tip shroud for a turbine blade.

### 2. Description of the Related Art

In an industrial gas turbine engine, hot compressed gas is produced. The hot gas flow is passed through a turbine and expands to produce mechanical work used to drive an electric generator for power production. The turbine generally includes multiple stages of stator vanes and rotor blades to convert the energy from the hot gas flow into mechanical energy that drives the rotor shaft of the engine. Turbine inlet temperature is limited by the material properties and cooling capabilities of the turbine parts.

A combustion system receives air from a compressor and raises it to a high energy level by mixing in fuel and burning the mixture, after which products of the combustor are expanded through the turbine.

Gas turbines are becoming larger, more efficient, and more robust. Large blades and vanes are being produced, especially in the hot section of the engine system.

A turbine blade is formed from a root portion coupled to a rotor disc and an airfoil that extends outwardly from a platform coupled to the root portion. The blade is ordinarily composed of a tip opposite the root section, a leading edge, and a trailing edge. The tip of a turbine blade often has a tip feature to reduce the size of the gap between stationary casing and rotating blades in the gas path of the turbine to prevent tip flow leakage. The tip leakage flow reduces the amount of torque generated by the turbine blades, however, the tip feature may mitigate the leakage as much as possible.

In current assemblies, gas turbine hot section blade tips have very complex geometries to reduce the tip leakage from the pressure to suction sides and provide rub damage tolerance. Features such as squealer tips with complicated cooling schemes have been the primary approach to manage these topics.

For most gas turbine blades, pull loads and cooling requirements eliminate the possibility of certain tip shrouds for blades within a gas turbine hot section. There are, therefore, significant rub issues in the field which result in reduced performances and limitations on engine operability. The rotating blade tips and cavity configurations in large industrial gas turbines are regions of low performance. There are several drivers of aerodynamic loss in the turbine-shroud cavity configuration, which lowers the gas turbine's efficiency. One driver is the flow over the rotating blade tip seal. Tip seals are generally designed to choke the flow and consequently lead to high flow velocities in the turbine tip-shroud cavity. The mixing losses that occur downstream of the seal are high and contribute to a reduction in stage efficiency and power. Additional mixing losses occur when the flow through the tip cavity combines with the main flow and the two streams have different velocities.

### SUMMARY

In one aspect of the present invention, a blade and tip shroud assembly for a gas turbine engine comprises: at least one blade with an airfoil extending span-wise along a radial direction, each blade airfoil comprising a blade tip; at least one tenon that extends radially out from the blade tip; a ceramic matrix composite (CMC) tip shroud positioned along the blade tip, the CMC tip shroud extending generally along a circumferential direction, the CMC tip shroud comprising: an upstream edge and a downstream edge spaced apart from each other in an axial direction covering at least a full chordwise length of the blade tip; a radially inner diameter (ID) surface adjoining the blade tip and a radially outer diameter (OD) surface opposite to the radially ID surface; a securing mechanism connected to the outer diameter surface of the CMC tip shroud; and wherein the at least one tenon extends through the ceramic matrix composite tip shroud and attaches to the securing mechanism.

These and other features, aspects and advantages of the present invention will become better understood with reference to the following drawings, description and claims.

### BRIEF DESCRIPTION OF THE DRAWINGS

The invention is shown in more detail by help of figures. The figures show preferred configurations and do not limit the scope of the invention.

FIG. 1 is a perspective view of a gas turbine engine with a row of shrouded turbine blades wherein aspects of the present invention may be incorporated.

FIG. 2 is a radial top view of an exemplary embodiment of the present invention.

FIG. 3 is a tangential view of an exemplary embodiment along section 3-3 of FIG. 2.

FIG. 4 is a axial view of an exemplary embodiment along section 4-4 of FIG. 2.

FIG. 5 is radial top view of an alternate embodiment of the present invention.

FIG. 6 is a tangential view of an exemplary embodiment along section 6-6 of FIG. 5.

FIG. 7 is a axial view of an exemplary embodiment along section 7-7 of FIG. 5.

### DETAILED DESCRIPTION

In the following detailed description of the preferred embodiment, reference is made to the accompanying drawings that form a part hereof, and in which is shown by way of illustration, and not by way of limitation, a specific embodiment in which the invention may be practiced. It is to be understood that other embodiments may be utilized and that changes may be made without departing from the spirit and scope of the present invention.

Broadly, an embodiment of the present invention provides a blade and tip shroud assembly for a gas turbine engine. The assembly includes at least one blade with an airfoil extending span-wise along a radial direction. Each blade includes a blade tip. At least one tenon extends radially out from the blade tip. A ceramic matrix composite (CMC) tip shroud is positioned along the blade tip. The CMC tip shroud extends along a circumferential direction and includes an upstream edge and a downstream edge spaced apart from each other in an axial direction. The CMC tip shroud includes a radially inner diameter (ID) surface adjoining the blade tip and a radially outer diameter (OD) surface opposite to the radially ID surface. A securing mechanism is connected to the OD surface of the CMC tip shroud and attached to the at least one tenon that extends through the CMC tip shroud.

A gas turbine engine may comprise a compressor section, a combustor and a turbine section. The compressor section compresses ambient air. The combustor combines the compressed air with a fuel and ignites the mixture creating combustion products comprising hot gases that form a working fluid. The working fluid travels to the turbine section. Within the turbine section are circumferential alternating rows of vanes and blades, the blades being coupled to a rotor. Each pair of rows of vanes and blades forms a stage in the turbine section. The turbine section comprises a fixed turbine casing, which houses the vanes, blades and rotor. The front, or first stages of, vanes and blades see higher temperatures than later stages.

Any leakage flow, or aerodynamic loss, that is not turned by the blades is lost work extraction, thus lowering the turbine efficiency. One area of concern is the flow over a rotating blade tip seal. The mixing losses that occur downstream of the seal are high and contribute to a reduction in stage efficiency and power. Additional mixing losses occur when the flow through the tip cavity combines with the main flow and the two streams have different velocities.

A reduction in losses by providing a ceramic matrix composite material (CMC) tip shroud on hot gas path rotating blades is desirable. Embodiments of the present invention provide a tip shroud configuration for a blade that may allow for the reduction in losses and may provide flow control features.

Using a ceramic matrix composite material for the tip shroud may improve the power output and performance of the stage as well as allow the tip shroud to be used in higher temperature stage blades such that leakage flow from pressure to suction side of the airfoil is reduced. Conventionally it is difficult to maintain small clearances along a front stage blade shrouded area. Metals cannot be used for tip shrouds in these areas due to blade pull. Using a CMC material may provide high temperature capability and reasonable strength at approximately a third of the weight of a metal.

A CMC tip shroud may be placed on a blade tip and run in a groove in a turbine case. Essentially zero clearance can be produced between the blade tip and the flow path. A CMC tip shroud may be attached to a blade tip, or multiple blade tips based on the embodiment desired.

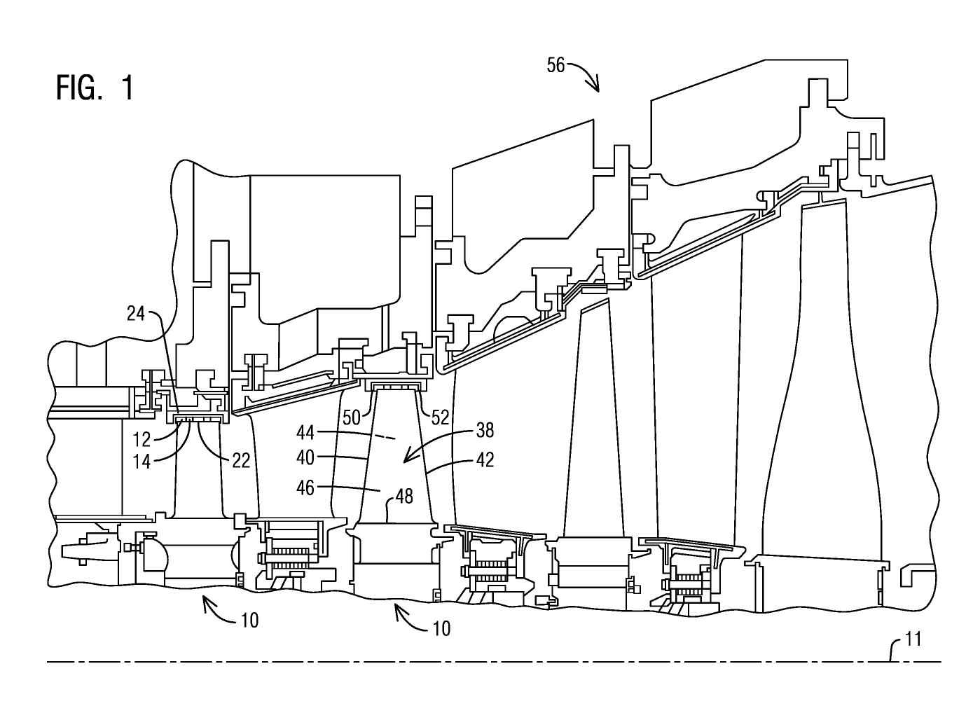

Referring to FIG. 1, a portion of a turbine section of a gas turbine engine 56 is shown, which includes a row of turbine blades 10 wherein embodiments of the present invention may be incorporated. The blades 10 are circumferentially spaced apart from each other to define respective flow passages between adjacent blades 10, for channeling the working fluid. The blades 10 are rotatable about a rotation axis along a centerline 11 of the turbine engine 56. Each blade 10 is formed from an airfoil 38 extending span-wise in a radial direction in the turbine engine 56 from a rotor disc. The airfoil 38 includes a leading edge 40, a trailing edge 42, a pressure side 44, a suction side 46 on a side opposite to the pressure side 44, a blade tip 22 at a radially outer end of the airfoil 38, a platform 48 coupled to the airfoil 38 at a radially inner end of the airfoil 38 for supporting the airfoil 38 and for coupling the airfoil 38 to the rotor disc. The blade 10 may further include a shroud 12, referred to as a tip shroud, and engage with the blade tip 22 of the generally elongated airfoil 38. The platform 48 forms a radially inner end wall, while the shroud 12 forms a radially outer end wall of the blade 10.

The shroud 12 includes an upstream edge 50 and a downstream edge 52. A radially inner diameter (ID) surface 32 adjoins the blade tip 22 of the airfoil 38. The shroud 12 includes a radially outer diameter (OD) surface 34 opposite to the radially inner surface 32. The radially inner surface 32 and the radially outer surface 34 connect at the upstream edge 50 and the downstream edge 52.

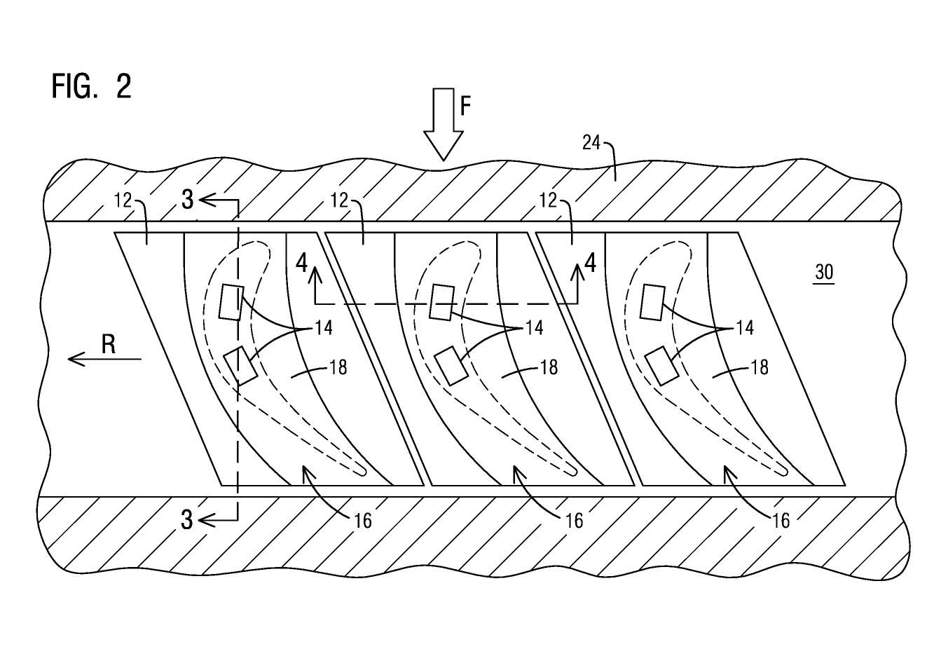

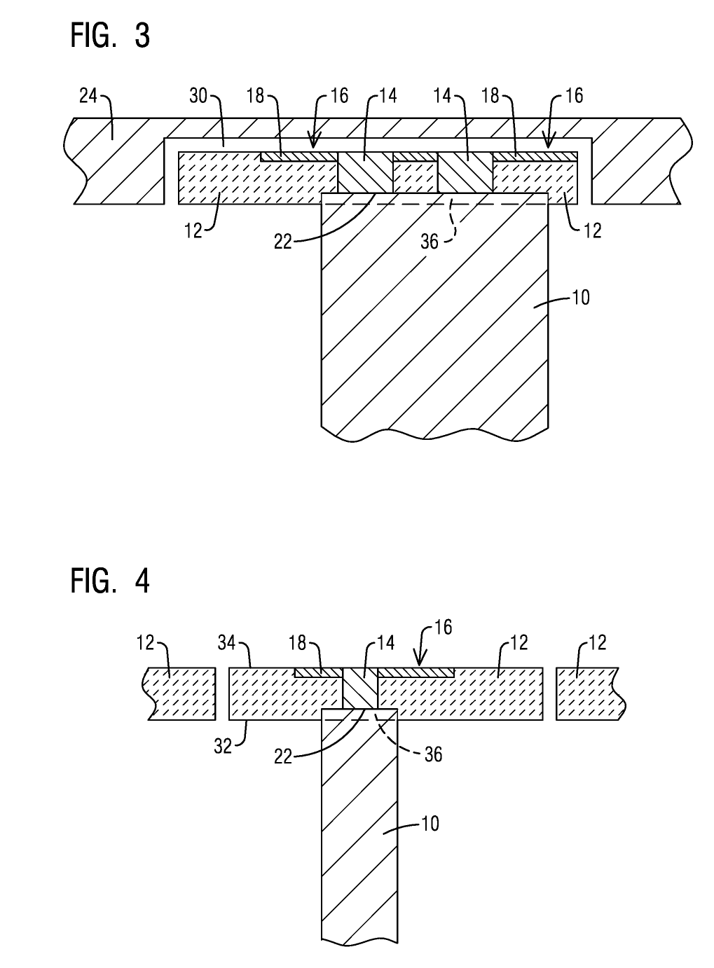

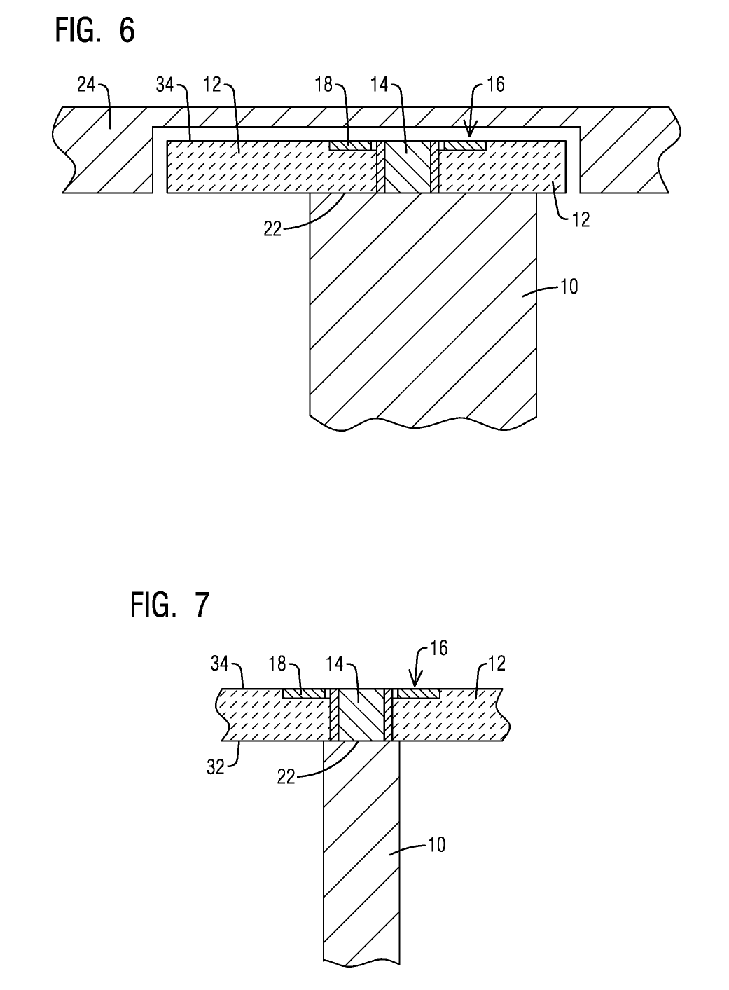

FIG. 2 shows the rotational direction (R) and the flow direction (F). Each blade 10 may include at least one tenon 14 that runs radially within the blade 10 and extends radially out from the blade tip 22 as shown in FIGS. 3, 4, 6, and 7.

A ceramic matrix composite material (CMC) tip shroud 12 may be attached to at least one blade tip 22. Each CMC tip shroud 12 includes the inner diameter (ID) surface 32 and the outer diameter (OD) surface 34. The CMC tip shroud 12 may include a cut out 36 along the ID surface 32 for a small gap for movement of the blade 10. The entire CMC tip shroud may move with the blade 10 while the blade untwists when in operation. Any local uncambering may be taken up by where the blade tip 22 contacts the ID surface 32 of the CMC tip shroud 12. The at least one tenon 14 may be used to attach the CMC tip shroud 12 to the blade tip 22. The tenon 14 may extend through the CMC tip shroud 12. The tenon 14 may then attach to a securing mechanism 16 that is positioned along the OD surface 34 of the CMC tip shroud 12.

The securing mechanism 16 may be a cover plate 18, at least one washer 20, or the like. The securing mechanism 16 required may depend on the CMC material. As long as the CMC tip shroud 12 has enough strength to hold itself along the corners of the CMC tip shroud 12, further securing would not be required. In an embodiment with at least one washer 20 as the securing mechanism 16, the at least one washer 20 may be welded or the like to the at least one tenon 14 or attached in some other known way. The at least one tenon 14 may be peened over, bolted, or the like.

In certain embodiments, the securing mechanism 16 may be embedded into the outer diameter (OD) surface 34 of the CMC tip shroud 12. A smooth OD surface 34 may be achieved through the embedding of the securing mechanism 16. In certain embodiments, the CMC tip shroud 12 may be fully constrained between the blade tip 22 and the securing mechanism 16. The coverage of the securing mechanism 16 may be based on the CMC tip shroud 12 bending load capacity.

The turbine case and parts of the turbine case such as a ring segment 24, may have a groove cut out 30. The CMC tip shroud 12 may ride in the groove forming the flow path. Reducing tip leakage, the path between the ring segment 24 and the blade tip 22 may provide a tortuous path.

Illustrated in FIGS. 2-4 are several different views of three adjacent blades 10 with CMC tip shrouds 12, securing mechanisms 16, and blade tenons 14. The securing mechanism 16 shown in FIG. 2 is a cover plate 18. As shown, the blade tenons 14 run through the CMC tip shroud 12 and are attached to the securing mechanism 16. The CMC tip shroud 12 may run in a circumferential cut out 30 in the flow path such that the flow path is smooth across the interface between the vane and the blade 10. This shape helps to protect the CMC tip shroud 12 from the hot gas path and may improve the aerodynamic performance of the blade. In certain embodiments, additional protective thermal barrier coating (TBC) barrier may be added to the CMC tip shroud 12 along the flow path surface. FIGS. 3 and 4 shows this embodiment from a tangential and axial view.

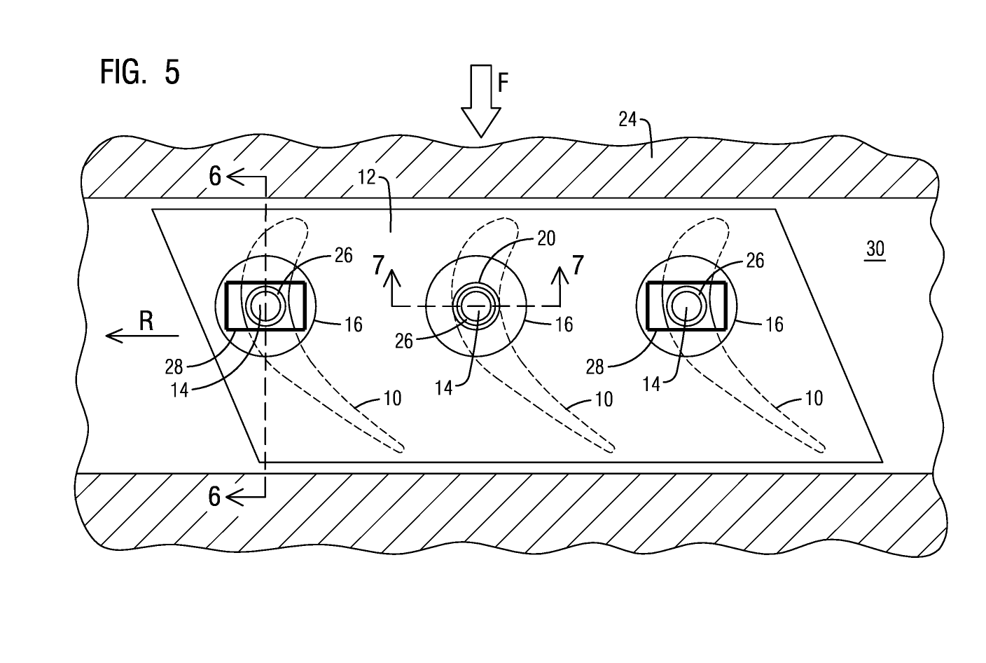

In another embodiment, for each CMC tip shroud there are multiple blade tips 22 such as shown in FIGS. 5-7. The number of blade tips 22 may be two, three, four, or more. In this embodiment, each blade may include at least one tenon 14, the tenon 14 located near the center of the twist. The CMC tip shroud 12 may then be located on these tenons and attached with a securing mechanism 16 such as the cover plate 18. The securing mechanism 16 may be circular such as shown in FIG. 5. The cover plate 18 may be shaped and sized to provide the structural support needed by the CMC tip shroud 12. In these embodiments, the need for the blades 10 to freely untwist requires that the blade tips 22 may not be embedded into the CMC tip shroud 12 like in some other embodiments. The ID surface 32 of the CMC tip shroud 12, also is a flow path surface, may be machined to permit a tight clearance fit with the CMC tip shroud 12, but allowing the blade tip 22 to be free to twist. With multiple blade tips 22 included with each CMC tip shroud 12, a central blade tenon 14 may have a fit that is tight with a protective wear bushing or the like to cover the tenon 14. The neighboring blade tenon 14 may have fits that may be allowed for both assembly and different thermal expansion between the CMC tip shroud 12 and the blade 10 radial growth. These neighboring tenons 14 may have fittings that may be slot shaped such as is shown in FIG. 5. The slot 28 may get longer in the circumferential direction as the number of covered blades 10 per tip shroud 12 increases. These slots 28 may also have a wear bushing 26 to protect the CMC tip shroud 12.

In embodiments with multiple blades, a central blade 10 may be fixed while the outlying blades 10 may be able to move freely. The blades 10 may be positioned so that the blades may still be able to twist. The bushings 26 may be fixed to the CMC tip shroud 12 and the at least one tenon 14 so the blade may twist. The bushings 26 may be added to provide for clearance.

The shape of the CMC tip shroud 12 would be dependent on the blade 10 placement. The shape may be such as the parallelogram as shown in the Figures, but not limited to this shape. The edges of the CMC tip shroud 12 may be trimmed in order to avoid contact with neighboring tip shrouds 12 as well as to avoid contact with the circumferential cut-out. The trimming would be on a level that would not expect to hurt the sealing performance and would be based also on the very small untwist of the gas turbine blade 10.

The thickness of the CMC tip shroud 12 may be determined by the material's bending stress capability. The thickness may be modified in both the axial and chord wise directions to reduce the unsupported bending loads. Another embodiment may include a plurality of lightening holes from the OD surface 34 of the CMC tip shroud 12 reducing weight. The lightening holes may incorporate a flow management pattern to further reduce tip leakage flow. This reduction of tip leakage flow may reduce the pull load and improve the tip sealing while maintaining the bending stress capability.

A method of attaching the CMC tip shroud 12 to a blade tip 22 may include installing the CMC tip shroud 12 on the blade tip by placing the tenons 14 through the CMC tip shroud 12. In certain embodiments, the blade tip 22 is embedded into the ID surface 32 of the CMC tip shroud 12 sometimes into a cutout 36 allowing for a tighter fit of the blade tip 22. In certain embodiments, the securing mechanism 16, such as the cover plate 18 or washer 20 as shown, is also then embedded into the CMC tip shroud 12. The blade tip 22, while embedded into the CMC tip shroud 12 would not require a squealer tip or some other such special feature.

The CMC tip shroud 12 may reduce rotating blade tip leakage. The CMC material may help make it more difficult for the air to get across the blade 10. The requirement of cooling the blade tips 22 can be reduced through the use of CMC tip shrouds 12. Cooling circuits may not be necessary. A reduction of costs can be achieved with more simplified blade tip geometries that are available with the CMC tip shroud 12. Other processes or procedures can also be eliminated with the CMC tip shroud 12. The addition of ring segment rub strip coatings and active clear control via Hydraulic Clearance Optimization (HCO) can be eliminated through the use of a CMC tip shroud 12. Generally, HCO moves the entire rotor forward and aft to manage clearance. To start operation, the rotor would be pushed backwards waiting for stabilization then moved back. This optimization would not be needed with the current application of tip shroud. The CMC tip shroud 12 may desensitize tip clearances sufficiently that active clearance control is not required. If necessary, the CMC tip shrouds 12 may be cooled using air from the blade internal passages. Cooling may also be provided from the ring segment.

While specific embodiments have been described in detail, those with ordinary skill in the art will appreciate that various modifications and alternative to those details could be developed in light of the overall teachings of the disclosure. Accordingly, the particular arrangements disclosed are meant to be illustrative only and not limiting as to the scope of the invention, which is to be given the full breadth of the appended claims, and any and all equivalents thereof.

What is claimed is:

1. A blade and tip shroud assembly for a gas turbine engine comprising:
at least one blade with an airfoil extending span-wise along a radial direction, each blade airfoil comprising a blade tip;
at least one tenon that extends radially out from the blade tip;
a ceramic matrix composite (CMC) tip shroud positioned along the blade tip, the CMC tip shroud extending generally along a circumferential direction, the CMC tip shroud comprising:
an upstream edge and a downstream edge spaced apart from each other in an axial direction covering at least a full chordwise length of the blade tip;
a radially inner diameter (ID) surface adjoining the blade tip and a radially outer diameter (OD) surface opposite to the radially ID surface;
a securing mechanism connected to the outer diameter surface of the CMC tip shroud; and
wherein the at least one tenon extends through the ceramic matrix composite tip shroud and attaches to the securing mechanism.

2. The blade and tip shroud assembly according to claim 1, wherein each blade tip is embedded into the ID surface of the CMC tip shroud, wherein the ID surface comprises a cutout, wherein the blade tip is embedded into the cutout.

3. The blade and tip shroud assembly according to claim 1, wherein a ceramic matrix composite tip shroud inner diameter surface is machined for a blade tip to fit to the ceramic matrix composite tip shroud.

4. The blade and tip shroud assembly according to claim 1, wherein the securing mechanism is a cover plate.

5. The blade and tip shroud assembly according to claim 4, wherein the cover plate is embedded into the ceramic matrix composite tip shroud.

6. The blade and tip shroud assembly according to any of claims 1 through 3, wherein the securing mechanism is at least one washer.
